(19) United States
(12) Patent Application Publication
(10) Pub. No.: US 2014/0223551 A1
(43) Pub. Date: Aug. 7, 2014

(54) ELECTRONIC DEVICE AND CONTROL METHOD FOR ELECTRONIC DEVICE

(71) Applicant: HON HAI PRECISION INDUSTRY CO., LTD., New Taipei (TW)

(72) Inventors: TAY-YANG LIN, New Taipei (TW); CHIN-FENG CHEN, New Taipei (TW); SHU-MING LIU, New Taipei (TW); CHIA-JUNG LIU, New Taipei (TW); YI-RU LAI, New Taipei (TW); PO-SUNG CHUANG, New Taipei (TW)

(73) Assignee: HON HAI PRECISION INDUSTRY CO., LTD., New Taipei (TW)

(21) Appl. No.: 14/161,652

(22) Filed: Jan. 22, 2014

(30) Foreign Application Priority Data
Feb. 4, 2013 (TW) 102104263

(51) Int. Cl. G06F 21/44; G06F 3/01; G06F 21/32

(52) U.S. Cl. CPC G06F 21/44; G06F 21/32; G06F 3/017
USPC 726/19

(57) ABSTRACT

An electronic device includes a base and a cover rotatably attached to the base. An identification unit is located on the cover. The identification unit is used to sense a gesture to rotate the cover relative to the base. The disclosure further offers a control method for the electronic device.

### BACKGROUND

1. Technical Field

The present disclosure relates to an electronic devices and a control method for the electronic device.

2. Description of Related Art

An electronic device, such as a notebook, comprises a base and a cover rotatably attached to the base. Some confidential data is stored in the electronic device, so that the cover needs to be rotatable relative to the base for security. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like-reference numerals designate corresponding parts throughout the several views.

FIG. 1 is an isometric view of an embodiment of an electronic device.

FIG. 2 is a block diagram of the electronic device of FIG. 1.

FIG. 3 is a schematic diagram of the electronic device of FIG. 1.

FIG. 4 is a flowchart of an embodiment of a control method for the electronic device of FIG. 1.

FIG. 5 is a detail flowchart of an embodiment of the control method of FIG. 4.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

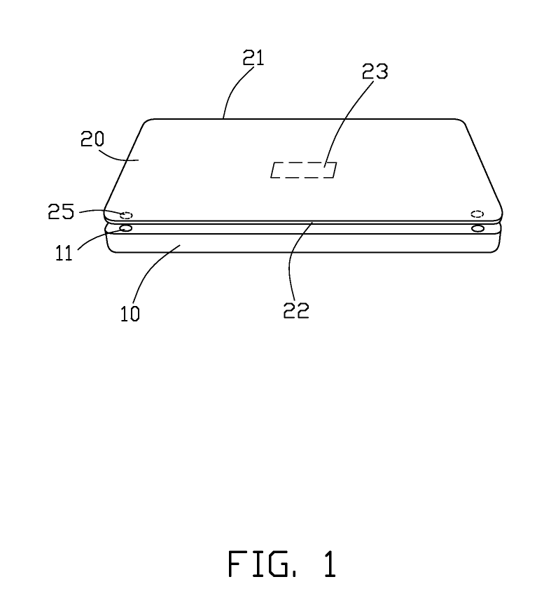

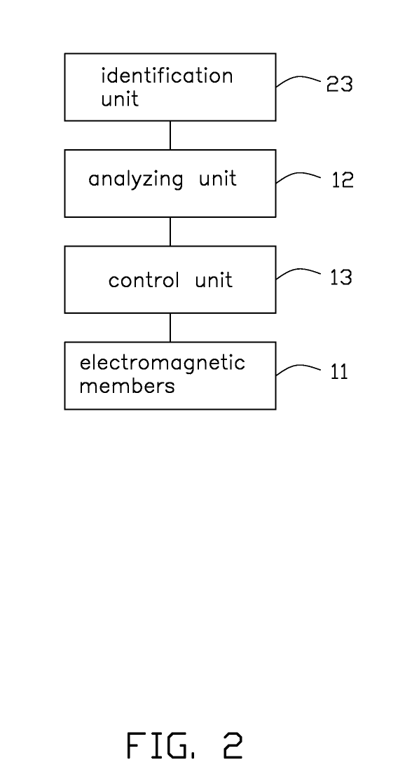

FIGS. 1-2 illustrate an embodiment of an electronic device. The electronic device comprises a base 10 and a cover 20.

The cover 20 comprises a rotating end 21 and an opposite free end 22. The rotating end 21 is rotatably attached to the base 10. An identification unit 23 is located on the cover 20. In one embodiment, the identification unit 23 is set as a logo of the electronic device, and is enclosed by a nanometer carbon tube. A pair of securing members 25 is located on opposite sides of the free end 22. The pair of securing members 25 are magnetic.

A pair of electromagnetic members 11, corresponding to the pair of securing members 25, are located on the base 10. An analyzing unit 12 and a control unit 13 are located in the base 10. The analyzing unit 12 is connected to the identification unit 23. The control unit 13 is connected to the analyzing unit 12 and the electromagnetic members 11.

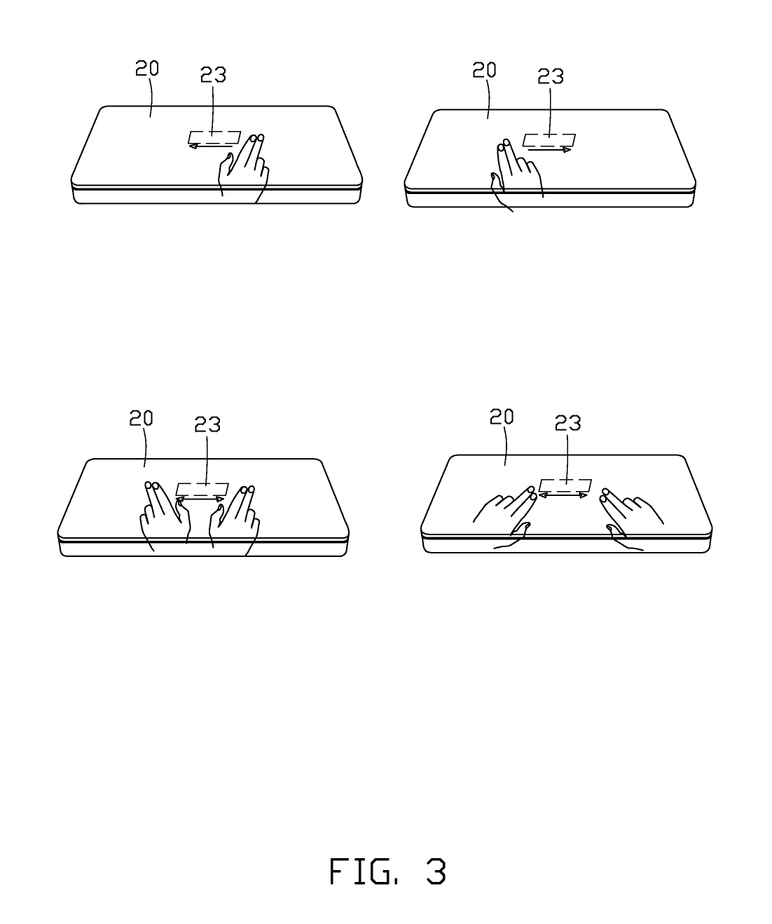

FIG. 3 illustrates in use, the identification unit 23 is a touch panel for sensing a gesture of a user. For example, a first gesture from left to right, a second gesture from right to left, a third gesture away from the identification unit 23, and a fourth gesture towards the identification unit 23. When the identification unit 23 senses the first to fourth gestures, the identification unit 23 generates sensing signals to send to the analyzing unit 12.

The analyzing unit 12 is used to analyze whether a finger belongs to an authorized person according to the sensing signals that are generated by the identification unit 23, so that the analyzing unit 12 can generate different control signals. For example, when the analyzing unit 12 analyzes the finger belongs to the authorized person, the analyzing unit 12 analyzes a style of the gesture to generate a first control signal which is sent to the control unit 13, and the control unit 13 controls the electronic device according to the first control signal. When the analyzing unit 12 analyzes the finger does not belong to an authorized person, the analyzing unit 12 sends a second (lock) control signal different from the first control signal to the control unit 13 which locks the electronic device.

The different control signals generated from the analyzing unit 12 further comprises a Galvanical signal and a cold signal that is different from the first and second control signals. The Galvanical signal and the cold signal are used to control the pair of electromagnetic members 11. For example, when the authorized person uses the first gesture, the analyzing unit 12 sends the Galvanical signal of the electromagnetic members 11 to the control unit 13. The control unit 13 powers on the electromagnetic members 11 thus generating a magnetic force. When the cover 20 covers the base 10, the electromagnetic members 11 attract the securing members 25, and the cover 20 is secured to the base 10. When the authorized person uses the second gesture, the analyzing unit 12 sends the cold signal of the electromagnetic members 11 to the control unit 13. The control unit 13 powers off the electromagnetic members 11 according to the cold signal, and the magnetic force of the electromagnetic members 11 is dissipated. Thus, the electromagnetic members 11 do not attract the securing members 25, and the cover 10 can be rotatable relative to the base 10.

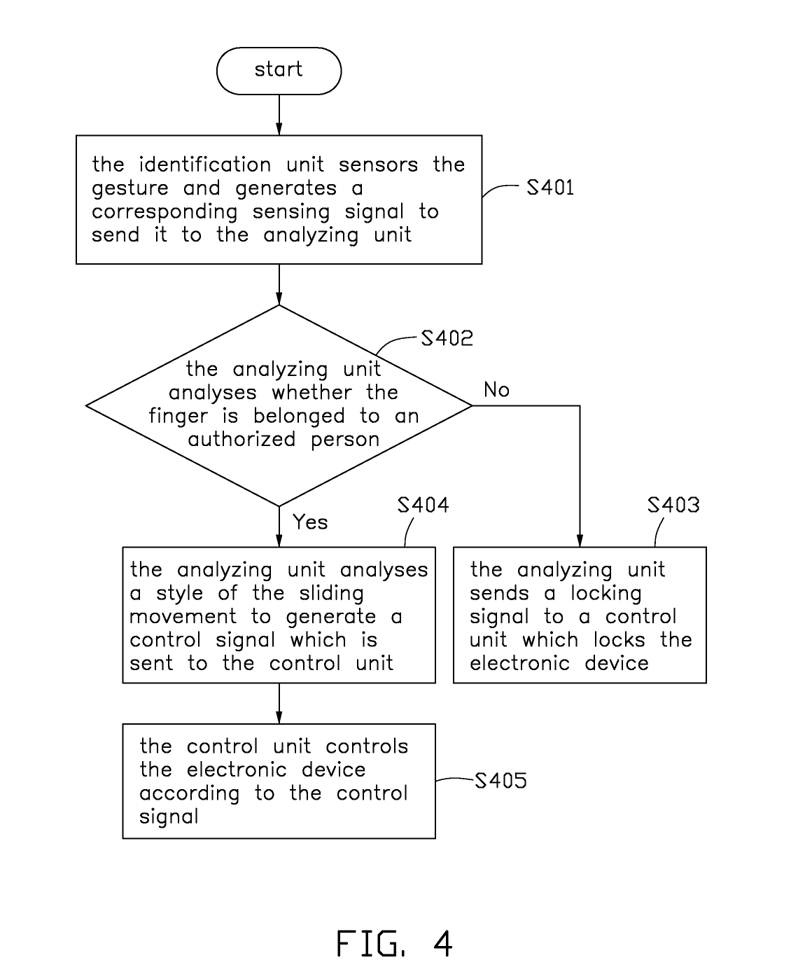

FIG. 4 illustrates an embodiment of a control method for the electronic device. The method comprises the following steps:

S401: the identification unit 23 sensors the gesture and generates a sensing signal to send it to the analyzing unit 12.

S402: the analyzing unit 12 analyzes whether the finger belongs to an authorized user.

S403: the analyzing unit 12 sends the second signal to a control unit 13 which locks the electronic device.

S404: the analyzing unit 12 analyzes a style of the gestures to generate different control signals, which are sent to the control unit 13.

S405: the control unit 13 controls the electronic device according to the different control signals.

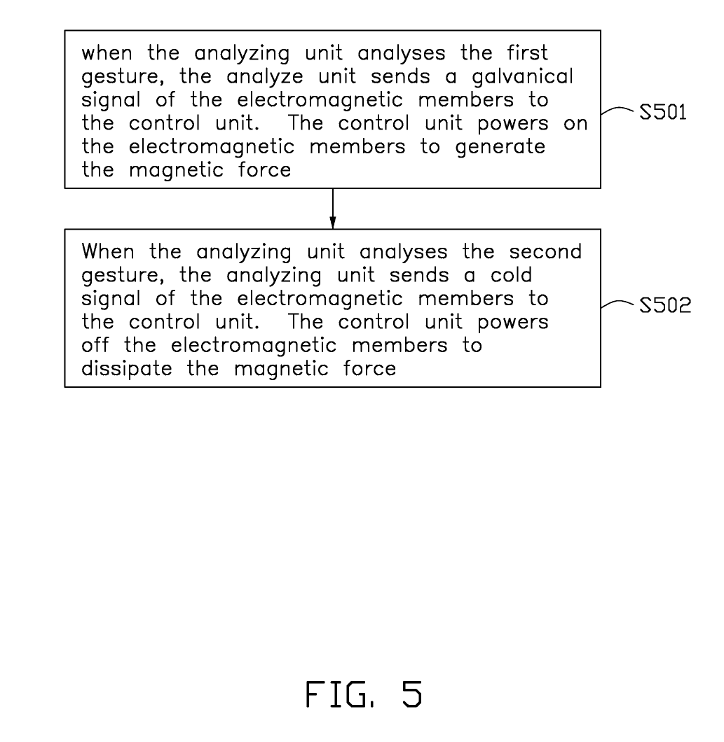

FIG. 5 illustrates an embodiment of the step S405. The method comprises the following steps:

S501: when the analyzing unit 12 analyzes the first gesture, the analyzing unit 12 sends the Galvanical signal of the electromagnetic members 11 to the control unit 13. The control unit 13 powers on the electromagnetic members 11, so that a magnetic force is generated.

S502: When the analyzing unit 12 analyzes the second gesture, the analyzing unit 12 sends the cold signal of the electromagnetic members 11 to the control unit 13. The control unit 13 powers off the electromagnetic members 11 and the magnetic force of the electromagnetic members 11 is dissipated.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An electronic device comprising:
a base; and
a cover rotatably attached to the base; an identification unit located on the cover;
wherein the identification unit is configured to sense a gesture to rotate the cover relative to the base.

2. The electronic device of claim 1, wherein the identification unit is a touch screen that is enclosed by a nanometer carbon tube.

3. The electronic device of claim 1, wherein the base comprises an analyzing unit, and the identification unit is configured to generate a sensing signal according to the gesture to send to the analyzing unit.

4. The electronic device of claim 3, wherein the analyzing unit is configure to analyze the finger is belonged to an authorized person according to the sensing signal.

5. The electronic device of claim 4, wherein the base comprises a control unit, the analyzing unit is configure to generate a control signal according the sensing signal, to sent to the control unit.

6. The electronic device of claim 5, wherein the base further comprises an electromagnetic member, the cover comprises a securing member, the securing member is secured to the electromagnetic member when a magnetic force is in the electromagnetic member, and the securing member is removed from the electromagnetic member when the magnetic force is dissipated from the electromagnetic member.

7. The electronic device of claim 6, wherein when the analyzing unit analyzes a first gesture, the analyzing unit send a Galvanical signal of the electromagnetic member to the control unit, and the control unit powers on the electromagnetic member to generate the magnetic force.

8. The electronic device of claim 7, wherein when the analyzing unit analyzes a second gesture that is different from the first gesture, the analyzing unit sends a cold signal of the electromagnetic member to the control unit, and the control unit powers off the electromagnetic member to dissipate the magnetic force.

9. A control method comprising:
sensing a sensing signal by an identification unit on a cover of an electronic device;
sending the sensing signal to an analyzing unit by the identification unit;
analyzing whether a finger is belonged to an authorized person according to the sensing signal; and
when the finger is not belonged to an authorized person, the analyzing unit sends a locking signal to a control unit which locks the electronic device; when the finger is belonged to an authorized person, the analyzing unit generates a control signal to send to the control unit, and the control unit controls the electronic device according to the control signal.

10. The control method of claim 9, wherein the identification unit is a touch screen that is enclosed by a nanometer carbon tube.

11. The control method of claim 9, further comprising: a securing member on the cover is secured to an electromagnetic member of a base of the electronic device, when a magnetic force is in the electromagnetic member, and the securing member is removed from the electromagnetic member when the magnetic force is dissipated from the electromagnetic member.

12. The control method of claim 11, wherein when the analyzing unit analyzes a first gesture, the analyzing unit sends a Galvanical signal of the electromagnetic member to the control unit, and the control unit powers on the electromagnetic member to generate the magnetic force.

13. The control method of claim 12, wherein when the analyzing unit analyzes a second gesture that is different from the first gesture, the analyzing unit sends a cold signal of the electromagnetic member to the control unit, and the control unit powers off the electromagnetic member to dissipate the magnetic force.
